(19) United States
(12) Patent Application Publication
(10) Pub. No.: US 2009/0235809 A1
(43) Pub. Date: Sep. 24, 2009

(54) System and Method for Evolving Music Tracks

(75) Inventors: Kenneth O. Stanley, Oviedo, FL (US); Michael Rosario, Winter Park, FL (US); Amy Kathryn Hoover, Oviedo, FL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: University of Central Florida Research Foundation, Inc., Orlando, FL (US)

(21) Appl. No.: 12/409,815

(22) Filed: Mar. 24, 2009

Related U.S. Application Data
(60) Provisional application No. 61/038,896, filed on Mar. 24, 2008.

(51) Int. Cl. G10H 1/40

(52) U.S. Cl. 84/611

(57) ABSTRACT

Systems and methods of generating music tracks are disclosed. One such method, for generating one type of music track from another type of music track, is implemented in a computer. The method includes the steps of receiving a music track input having a first type into an artificial neural network (ANN), and producing a music track output having a second type from the ANN, based upon the music track input having the first type.

### CROSS REFERENCE TO RELATED APPLICATIONS

This application claims the benefit of U.S. Provisional Application No. 61/038,896, filed Mar. 24, 2008, which is hereby incorporated by reference.

### FIELD OF THE DISCLOSURE

The present disclosure relates generally to computer generation of music, and more specifically, to systems and methods of evolving music tracks.

### BACKGROUND

Some computer-generated music uses interactive evolutionary computation (IEC), by which a computer generates a random initial set of music tracks, then a human selects aesthetically pleasing tracks that are used to produce the next generation. However, even with human input for selecting the next generation, computer-generated music often sounds artificial and uninspired. Also, computer-generated music often lacks a global structure that holds together the entire song.

### BRIEF DESCRIPTION OF THE DRAWINGS

FIG. 1 is a block diagram depicting an example system for evolving a rhythm in accordance with various embodiments disclosed herein.

FIG. 2 is a diagram depicting one example Compositional Pattern Producing Network Artificial Neural Network (CPPN) generated and/or evolved by the system depicted in FIG. 1.

FIG. 3 is an illustration of an example graphical user interface (GUI) of a system as depicted in FIG. 1.

FIG. 4 is a diagram depicting another example CPPN generated and/or evolved by the system depicted in FIG. 1.

FIG. 5 is an illustration of another example graphical user interface (GUI) of a system as depicted in FIG. 1.

FIG. 6 is a diagram depicting yet another example CPPN generated and/or evolved by the system depicted in FIG. 1.

FIGS. 7A-C are diagrams depicting various temporal patterns used as input by some of the CPPN embodiments described herein.

FIG. 8 is a flowchart depicting example architecture and functionality of the system depicted in FIG. 1.

### DETAILED DESCRIPTION

Music may be represented as a function of time. In this regard, where t=0 indicates the beginning of a song and t=n indicates the end of a song, there is a function f(t) that embodies a pattern equivalent to the song itself. However, with respect to the song, the function f(t) may be difficult to formulate. While it may be difficult to formulate a function f(t) indicative of the song itself, the song has recognizable structure, which varies symmetrically over time. For example, the time in measure increases from the start of the measure to the end of the measure then resets to zero for the next measure. Thus, a particular song exhibits definable variables including time in measure (“m”) and time in beat (“b”). These variables may then be used as arguments to a function, e.g., g(m, b, t), which receives the variables as arguments at any given time and produces a note or a drum hit for the given time.

Over the period t=0 to t=n, these note or drum hit outputs comprise a rhythm exhibiting the structure of the song. In this regard, the rhythm output produced by the function will move in accordance with the function input signals, i.e., the time in measure and the time in beat over the time period t=0 to t=n. Thus, g(m, b, t) will output a function of the song structure, i.e., time in measure and time in beat, and the output will sound like rhythms indicative of the song.

These measure, beat and time inputs act as temporal patterns or motifs which directly describe the structure of the song as it varies over time. Notably, the song itself encodes this structure, although it does not directly describe it. Thus, extending the concept described above, tracks of the song itself can be used as inputs to a function which produces a rhythm output. This concept is referred to herein as “scaffolding”. Since the scaffolding tracks already embody the intrinsic contours and complexities of the song, the rhythm output inherits these features and therefore automatically embodies the same thematic elements.

In this disclosure, the temporal patterns or motifs which are inputs separate from the song itself are called “conductors”, as a analogy with the silent patterns expressed by a conductor's hands to an orchestra. Rhythms produced as a function of conductors and rhythms produced as a function of the song scaffolding are each interesting in their own right. The conductor inputs and the scaffolding inputs can also used in combination to produce a rhythm having a temporal frame that is independent of the song itself. In other words, the individual notes of rhythm output are situated within coordinate frames that describe how the user wants to vary the rhythm a meta-level. The resulting rhythm sounds more creative because it is not committed to exact structure of song. The combination of conductors and scaffolding offers the user a subtle yet powerful mechanism to influence the overall structure of the rhythm output, without the need for a note-by-note specification.

The transformation function g(t) described above which generates a rhythm as a function of various inputs can be implemented by, or embodied in, a type of artificial neural network called a Compositional Pattern Producing Network (CPPN). Viewed another way, the CPPN encodes a rhythm. The systems and methods disclosed herein generate an initial set of CPPNs which produce a rhythm output from a set of timing inputs. A user selects one or more CPPNs from the initial population, and the systems and methods evolve new CPPNs based on the user selections.

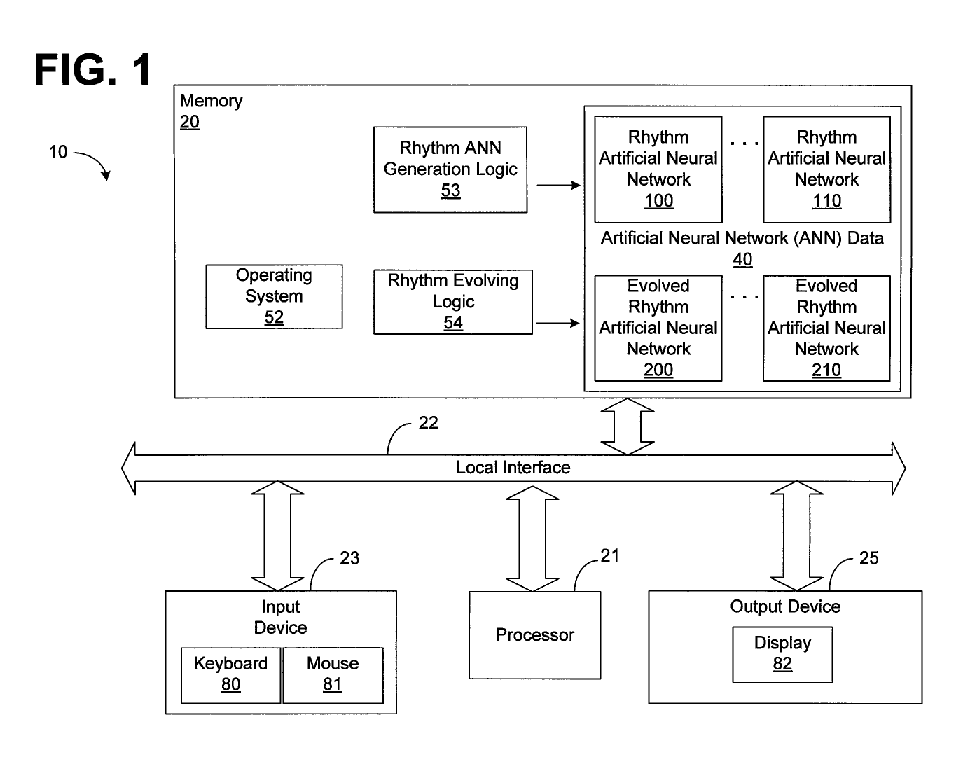

FIG. 1 illustrates an example rhythm-evolving system 10. As indicated in FIG. 1, the rhythm-evolving system 10 generally comprises a processor 21, memory 20, and one or more input/output (110) devices 23 and 25, respectively, each of which is connected to a local interface 22.

The processor 21 includes a commercially available or custom-made processor, a central processing unit (CPU), an auxiliary processor among several processors associated with the rhythm-evolving system 10, or a semiconductor-based microprocessor (in the form of a microchip). The memory 20 can include any one or a combination of volatile memory elements (e.g., random access memory (RAM)) and nonvolatile memory elements (e.g., hard disk, compact disk (CD), flash memory, etc.). The I/O devices 23 and 25 comprise those components with which a user can interact with the rhythm-evolving system 10, such as a display 82, keyboard 80, and a mouse 81, as well as the components that are used to facilitate connection of the computing device to other devices (e.g., serial, parallel, small computer system interface (SCSI), or universal serial bus (USB) connection ports).

Memory 20 stores various programs, in software and/or firmware, including an operating system (O/S) 52, artificial neural network (CPPN) generation logic 53, and rhythm-evolving logic 54. The O/S 52 controls execution of other programs and provides scheduling, input-output control, file, and data management, memory management, and communication control and related services. In addition, memory 20 stores artificial neural network (CPPN) data 40 comprising a plurality of rhythm artificial neural networks 100-110 and a plurality of evolved rhythm artificial neural networks 200-210.

During operation, the CPPN generation logic 53 generates the plurality of CPPNs 100-110 that produce a plurality of respective rhythms, e.g., drum rhythms. In this regard, each CPPN 100-110 receives one or more inputs containing timing information (described further herein), and produces an output that is an audible representation of the rhythm embodied in the respective CPPNs 100-110.

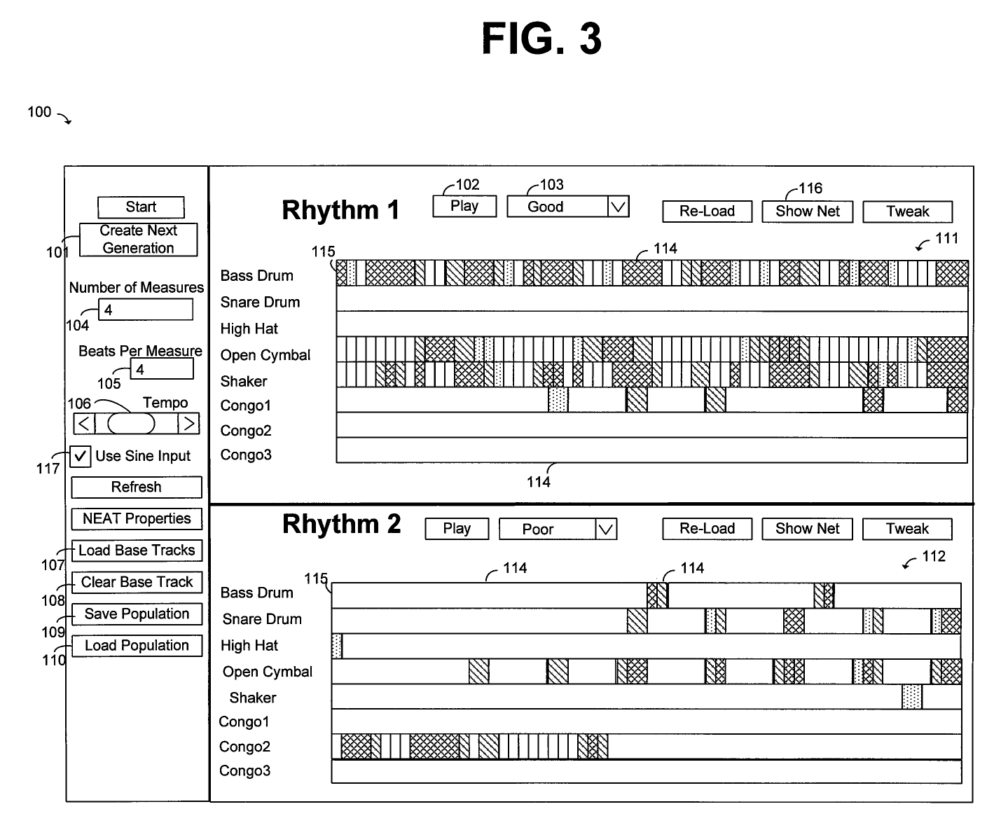

Once the CPPNs 100-110 are generated, the CPPN evolving logic 53 displays one or more graphical representations of the rhythms embodied in the CPPNs 100-110 to a user (not shown) via the display 82. A graphical display of the rhythms embodied in the CPPNs 110-110 is described further with reference to FIG. 3.

The graphical representations displayed via the display device 82 enable the user to visually inspect varying characteristics of each of the rhythms embodied in the CPPNs 100-110. In addition and/or alternatively, the user can listen to each of the rhythms and audibly discern the different characteristics of the plurality of rhythms. The user then selects one or more rhythms exhibiting characteristics that the user desires in an ultimate rhythm selection.

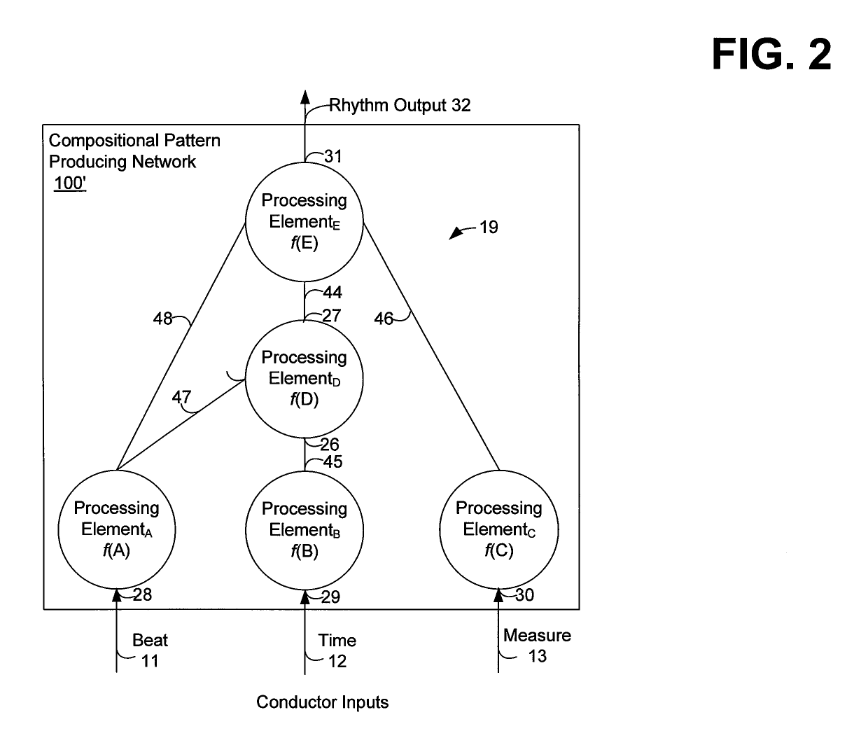

After selection of one or more rhythms by the user, the CPPN evolving logic 54, generates a plurality of evolved CPPNs 200-210. In one embodiment, the CPPN evolving logic 54 generates the CPPNs 200-210 by employing a Neuroevolution of Augmenting Topologies (NEAT) algorithm. The NEAT algorithm is described in “Evolving Neural Networks through Augmenting Topologies,” in the MIT Press Journals, Volume 10, Number 2 authored by K. 0. Stanley and R. Mikkulainen, which is incorporated herein by reference. The NEAT algorithm and its application within the rhythm-evolving system 10 are described hereinafter with reference to FIGS. 2 and 3.

In employing NEAT to evolve the CPPNs 200-210, the CPPN evolving logic 54 may alter or combine one or more of the CPPNs 100-110. In this regard, the CPPN evolving logic 54 may mutate at least one of the CPPNs 100-110 or mate one or more of the CPPNs 100-110 based upon those selected by the user. The user may select, for example, CPPNs 100-105 as exhibiting characteristics desired in a rhythm by the user. With the selected CPPNs 100-105, the evolving logic 54 may select one or more of the CPPNs 100-105 selected to mate and/or mutate. Furthermore, the evolving logic 54 may apply speciation to the selected CPPNs 100-105 to form groups of like or similar CPPNs that the evolving logic 54 makes and/or mutates.

Once the evolving logic 54 mutates at least one CPPN 100-110 and/or mates at least two of the CPPNs 100-110, the evolving logic 54 stores the mutated and/or mated CPPNs 100-110 as evolved rhythm CPPNs 200-210. Once the evolving logic 54 generates one or more CPPNs 200-210, the evolving logic 54 displays a graphical representation of the evolved CPPNs 200-210 to the user, as described herein with reference to CPPNs 100-110. Again, the user can select one or more of the rhythms embodied in the CPPNs 200-210 as desirable, and the evolving logic 54 performs mutation and mating operations on those CPPNs embodying those rhythms desired by the user. This process can continue over multiple generations until a rhythm is evolved that the user desires. Several different embodiments will now be described.

FIG. 2 depicts an example CPPN 100′ indicative of the CPPNs 100-110 or CPPNs 200-210. The CPPN 100′ exhibits an example topology 19 having a plurality of processing elements A-E. The processing elements A-E are positioned with respect to each other as described further herein, and the processing elements A-E are connected through multiple connections 44-48. The CPPN 100′ receives input signals 11-13 and each of the processing elements A-E performs a function f(A)-f(E), respectively, on its received input(s). Each function f(A)-f(E) is referred to as an “activation function”, which is a mathematical formula that transforms on input(s) of a processing element A-E into one or more output rhythm signals 32. Thus, each input signal 11-13 can be viewed as comprising a series of time steps, where at each time step the CPPN 100′ transforms the combination of input timing signals 11-13 into one or more corresponding output rhythm signals 32, each of which represents a note or a drum hit for that time.

In some embodiments, output rhythm signal 32 is converted to the MIDI format. When associated with a particular percussion instrument (e.g., when a user makes the association via a user interface), a particular rhythm signal 32 indicates at what volume the instrument should be played for each time step. For ease of illustration, the example embodiment of FIG. 2 shows a single rhythm signal output 32, but other embodiments produce multiple rhythm output signals 32.

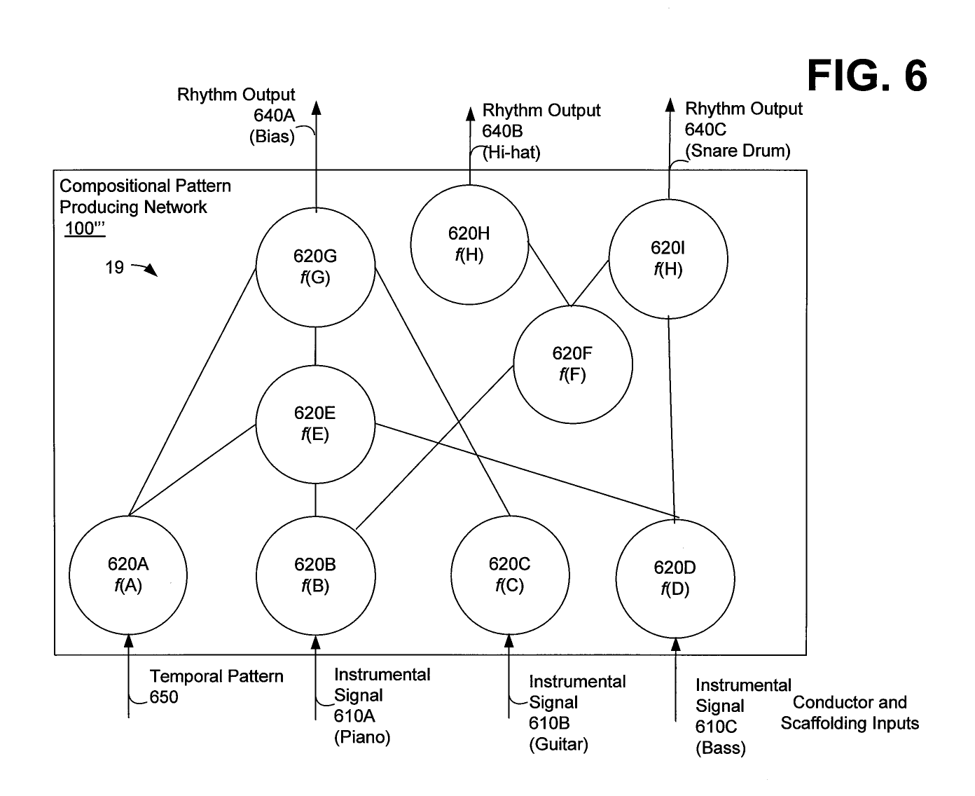

The input timing signals for the example CPPN 100′ of FIG. 3 are a beat signal 11, a time signal 12, and a measure signal 13 which encode the structure of a particular song. The beat signal 11, for example, may indicate the number of beats per measure, the time signal 12 may indicate the time signature, and the measure signal 13 may indicate the number measures for the generated rhythm. As described above, these measure, beat and time inputs are “conductors” which act as temporal patterns or motifs to directly describe the structure of the song as it varies over time. Some embodiments of CPPN 100′ also support arbitrary or artificial timing signals (described below in connection with FIG. 6).

Other inputs may be provided to the CPPN 100′. As an example, a sine wave may be provided as an input that peaks in the middle of each measure of the song, and the CPPN function may be represented as g(m, b, t, s) where “s” is the sine wave input. While many rhythms may result when the sine wave is provided as an additional input, the output produced by the function g(m, b, t, s) exhibits a sine-like symmetry for each measure.

To further illustrate the concept, consider the functions f(x) and f(sin(x)). In this regard, the function f(x) will produce an arbitrary pattern based upon the received input x. However, f(sin(x)) will produce a periodic pattern because it is a function of a periodic function, i.e., it varies symmetrically over time. Notably, a song also symmetrically varies over time. For example, the time in measure increases from the start of the measure to the end of the measure then resets to zero for the next measure. Thus, g(m, b, t) will output a function of the song structure, i.e., time in measure and time in beat, and the output will sound like rhythms indicative of the song.

Example activation functions implemented by processing elements A-E include sigmoid, Gaussian, or additive. The combination of processing elements within a CPPN can be viewed as applying the function g(m, b, t) (described above) to generate a rhythm signal 32 at output 31 in accordance with the inputs 11-13. Note that, unless otherwise specified, each input is multiplied by the weight of the connection over which the input is received. This support for periodic (e.g., sine) and symmetric (e.g., Gaussian) functions distinguishes the CPPN from an ANN.

As an example, f(D) may employ a sigmoid activation function represented by the following mathematical formula:

F(D)=2.0*(1.0/(1.0+exp(−1.0*x))))−1.0 A.1

In such an example, the variable x is represented by the following formula:

x=input 26*weight of connection 45+input 25*weight of connection 47, A.2 as

described herein.

As another example, f(D) may employ a Gaussian activation function represented by the following mathematical formula:

f(D)=2.5000*((1.0/sqrt(2.0*PI))*exp(−0.5*(x*x))) A.3

In such an example, the variable z is also represented by the formula A.2 described herein.

As another example, f(D) may employ a different Gaussian activation function represented by the following mathematical formula:

f(D)=(5.0138*(1/sqrt(2*PI))exp(−0.5(x*x)))−1

In such an example, the variable x is also represented by the formula A.2 described herein.

Numerous activation functions may be employed in each of the plurality of processing elements A-E, processing elements A-E, including but not limited to an additive function, y=x; an absolute value function, y=|x|; and exponent function, y=exp(x); a negative function y=−1.0*(2*(1.0/(1.0+exp(−1.0*x)))−1); a reverse function, if (value>0) y=2.50000*((1.0/sqrt(2.0*PI))* *exp(−8.0*(x*x))) else if (value<0) y=−2.5000*((1.0/sqrt(2.0*PI))*exp(−8.0*(x*x))); sine functions, y=sin((PI*x)/(2.0*4.0)), y=sin(x*PI), or y=sin(x*2*PI); an inverse Gaussian function y==2.5000*((1.0/sqrt(2.0*PI))*exp(−0.5*(value*value))); a multiply function, wherein instead of adding the connection values, they are multiplied and a sigmoid, e.g., A.1 is applied to the final product.

As an example, processing element D comprises inputs 25 and 26 and output 27. Further, for example purposes, the connection 45 may exhibit a connection strength of “2” and connection 47 may exhibit a connection strength of “1”. Note that the “strength” of a connection affects the amplitude or the numeric value of the particular discrete value that is input into the processing element. The function f(D) employed by processing element may be, for example, a summation function, i.e.,

F(D)=Σ(Inputs)=I*input 25+2*(input 26)=output 27.

Note that other functions may be employed by the processing elements A-E, as described herein, and the summation function used herein is for example purposes.

Note that the placement of the processing elements A-E, the activation functions f(A)-f(E), described further herein, of each processing element A-E, and the strength of the connections 44-48 are referred to as the “topology” of the CPPN 100′. The strength of the connections 44-48 may be manipulated, as described further herein, during evolution of the CPPN 100′ to produce the CPPNs 200-210 and/or produce a modified rhythm reflecting one or more of the CPPNs 100-110 mated or mutated. Notably, the strengths of the connections 44-48 may be increased and/or decreased in order to manipulate the output of the CPPN 100′.

As described earlier with reference to FIG. 1, the plurality of CPPNs 100-110 are generated by CPPN generation logic 53. The rhythm CPPN generation logic 53 randomly parameterizes in the topology 19, for example, ten different and/or varying connection strengths between their processing elements A-E and activation functions, and the connections made between the processing elements A-E may change from one generated CPPN 100-110 to another. Thus, while each of the CPPNs 100-110 receives the same inputs, the audible representation of the output signal 32 differ from one CPPN 100-110 to another.

In one embodiment, the CPPN generation logic 53 generates the initial population of CPPNs 100-110. This initial population may comprise, for example, ten (10) CPPNs having an input processing element and an output processing element. In such an example, each input processing element and output processing element of each CPPN randomly generated employs one of a plurality of activation functions, as described herein, in a different manner. For example, one of the randomly generated CPPNs may employ formula A.1 in its input processing element and A.2 in its output processing element, whereas another randomly generated CPPN in the initial population may employ A.2 in its input processing element and A.1 in its output processing element. In this regard, each CPPN generated for the initial population is structurally diverse.

Further, the connection weight of a connection 44-48 intermediate the processing elements of each CPPN in the initial population may vary as well. As an example, in one randomly generated CPPN the connection weight between the processing element A and B may be “2”, whereas in another randomly generated CPPN the connection weight may be “3”.

Once the CPPN generation logic 53 generates the initial population, a user may view a graphical representation or listen to the rhythm of each CPPN 100-110 generated. One such graphic representation will be described below in connection with FIG. 3, which illustrates a graphical user interface (GUI) 100. The GUI 100 comprises a plurality of grid representations 111 and 112 that graphically depict a rhythm, e.g., “Rhythm 1” and “Rhythm 2” respectively. Each grid 11 and 112 comprises a plurality of rows 115, each row corresponding to a specific instrument, for example a percussion instrument including but not limited to a “Bass Drum,” a “Snare Drum,” a “High Hat,” an “Open Cymbal,” and one or more Congo drums. Each row comprises a plurality of boxes 114 that are arranged sequentially to correspond temporally to the beat in the rhythm. That is, as one examines the rhythm from left to right along the row, each box 114 represents a beat, the next box 114 represents the next beat, etc. Notably, if the box 114 exhibits no color or shading, no beat for the corresponding instrument is played.

Furthermore, the strength at which the instrument beat is played is represented by the shading of the box 114: boxes with more shading represent a stronger instrument beat. Furthermore, the row 115 is a discrete number of music measures. For example, the row 115 associated with the Bass Drum may be sixteen (16) measures.

By examining the row 115 for an instrument, one can evaluate, based upon the visualization of the row 115, whether the rhythm for the instrument may or may not be an acceptable one. In addition, the GUI 100 comprises a button 102, and when selected, the CPPN activation logic 54 plays the rhythm graphically represented by the grid 111. Note that each of the grids 111 and 112 is a graphical representation of an CPPN1s output 100-110 or 200-210. Thus, one can select a “Show Net” button 16, and the evolving logic 54 shows an CPPN representation, as depicted in FIG. 2, of the rhythm under evaluation.

Once the user evaluates the rhythm by visually evaluating the grid 111 or listening to the rhythm, the user can rate the rhythm by selecting a pull-down buttons 103. The pull-down button 103 may allow the user to rate the rhythm, for example, as poor, fair, or excellent. Other descriptive words may be possible in other embodiments.

The GUI 100 further comprises a “Number of Measures” pull-down button 104 and a “Beats Per Measure” pull-down 105. As described herein, the rhythm displayed in grid 100 is a graphical representation of an CPPN's output 100-110 or the output of an CPPN 200-210 that generates the particular rhythm, where the CPPNs 100-110 and 200-210 further comprise beat, measure time inputs 11-13 (FIG. 2). Thus, if the user desires to change particular characteristics of the rhythm, e.g., the beats or the measure via pull-down buttons 104 and 105, the evolving logic 54 changes the inputs provided to the particular CPPN represented by the grid 111. The beat, measure, and time inputs 11-13 described herein are examples of conductor inputs, and other inputs may be provided in other embodiments to the CPPN 100′. The GUI 100 may be extended to allow modification of any input provided to the CPPN 100′.

Furthermore, the GUI 100 comprises a slide button 106 that one may used to change the tempo of the rhythm graphically represented by grid 111. In this regard, by moving the slide button 106 to the right, one can speed up the rhythm. Likewise, if one moves the slide button 106 to the left one can slow the rhythm.

The GUI 100 further comprises a “Load Base Tracks” button 107. A base track plays at the same time as the generated rhythm, allowing the user to determine whether or not a particular generated rhythm is appropriate for use as a rhythm for the base track. Further, one can clear the tracks that are used to govern evolution by selecting the “Clear Base Track” button 108.

Once each rhythm is evaluated, the user may then select the “Save Population” button 109 to save those rhythms that are currently loaded, for example, “Rhythm 1” and “Rhythm 2.”

Additionally, once one or more rhythms have been selected as good or acceptable as described herein, the user may then select the “Create Next Generation” button 101. The evolving logic 54 then evolves the selected CPPNs 100-110 corresponding to the selected or approved rhythms as described herein. In this regard, the evolving logic 54 may perform speciation, mutate, and/or mate one or more CPPNs 100-110 and generate a new generation of rhythms generated by the generated CPPNs 200-210. The user can continue to generate new generations until satisfied. The GUI 100 further comprises a “Use Sine Input” selection button 117. If selected, the evolving logic 54 may feed a Sine wave into an CPPN 100-110 or 200-210 as an additional input, for example, to CPPN 100′ (FIG. 2). When fed into the CPPN 100′, the rhythm produced by the CPPN 100′ will exhibit periodic variation based upon the amplitude and frequency of the Sine wave input.

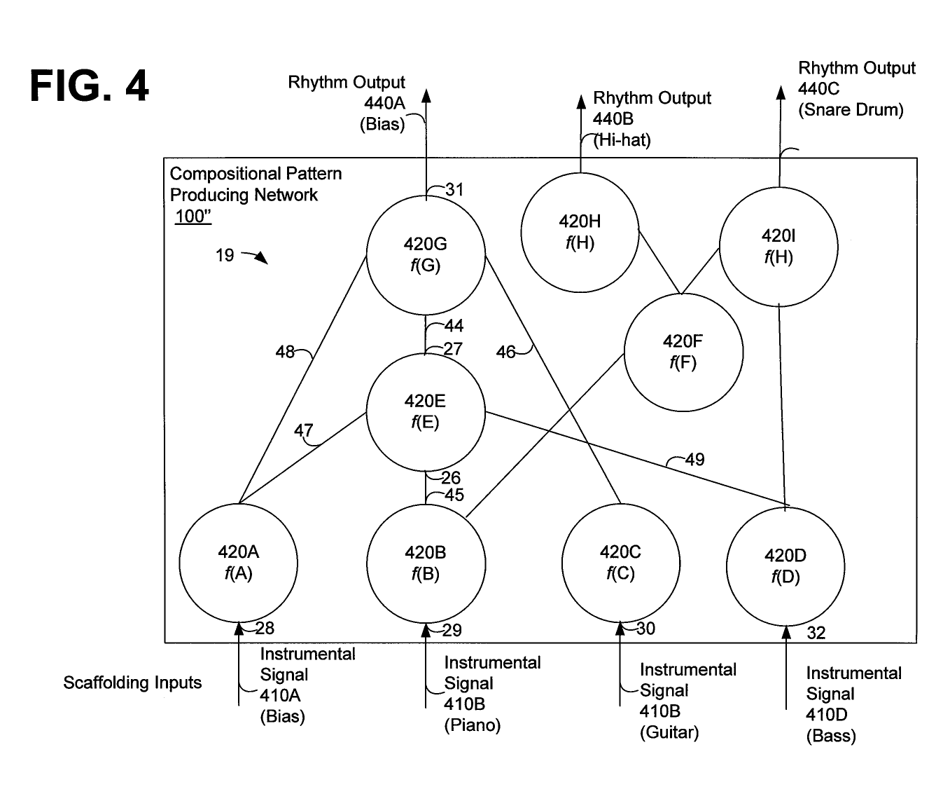

FIG. 4 depicts another example CPPN 100″ indicative of the CPPNs 100-110 or CPPNs 200-210. CPPN 100″ is similar to CPPN 100′ in that CPPN 100″ also contains inputs 410, processing elements 420, and can produce multiple rhythm outputs 440A-C. Each of rhythm outputs 440A-C can be associated (e.g., via a user interface) with a particular instrument that plays the signal (e.g., bass drum, hi-hat, snare drum, etc.) However, where the inputs to CPPN 100′ are conductors which directly encode timing information (e.g., time in beat, time in measure, time in song), the inputs 410 to CPPN 100″ are scaffolding: instrumental parts from a song, selected by a user. As used herein, the term “instrumental” refers to any track that is not a rhythm or drum track, including vocal tracks.

The example illustrated in FIG. 4 uses the following input signals: 410A is a bias signal; input 410B is a piano; input 410C is a guitar; and input 410D is a bass. The example illustrated in FIG. 4 uses the following rhythm output signals: 440A is a bass drum; 440B is a hi-hat; and 440C is a snare drum. In some embodiments, composite rhythm signal 440 and instrumental signals 410 are all converted to the MIDI format.

The NEAT algorithm implemented by CPPN 100″ takes advantage of the discovery that a portion of a song that is human-produced can be used to generate a natural-sounding rhythm for that song. The instrument signals 410 thus serve as scaffolding for the composite rhythm 440 produced by CPPN 100″. For drum or rhythm tracks in particular, one natural scaffolding is the music itself (e.g., melody and harmony), from which CPPN 100″ derives the rhythm pattern. The CPPN 100″ generates a composite rhythm 440 output that is a function of the instrument signals 410, such that the composite rhythm 440 is constrained by, although not identical to, the intrinsic patterns of the instrument signals 410. CPPN 100″ can be viewed as transforming the scaffolding instrument signals 410. Since the scaffolding already embodies the intrinsic contours and complexities of the song, such a transformation of the scaffold thus inherits these features and therefore automatically embodies the same thematic elements. The use of multiple instrument signals 410 (e.g., bass and guitar) results in a composite rhythm 440 with enhanced texture, since the composite rhythm 440 is then a function of both inputs.

Although the instrument signals 410 do not directly represent timing signals, CPPN 100″ derives timing signals from the instrument signals 410. CPPN generation logic 53 inputs the selected instrument signals 410 into each CPPN 100″ over the course of the song in sequential order, and records the consequent rhythm outputs 440A-C, each of which represents a rhythm instrument being struck. Specifically, from time t=0 to time t=l (where l is the length of the song), CPPN generation logic receives the song channel input signals 410 and samples the rhythm outputs 440A-C at discrete subintervals (ticks) up to l.

CPPN 100″ derives timing information from instrument signals 410 as follows. CPPN 100″ represents individual notes within each instrument signal 410 as spikes that begin high and decrease or decay linearly. The period of decay is equivalent to the duration of the note. The set of input signals 410 is divided into N ticks per beat. At each tick, the entire vector of note spike values at that discrete moment in time is provided as input to the CPPN 100″. In this manner, CPPN 100″ derives timing information from the instrument signals 410, while ignoring pitch, which is unnecessary to appreciate rhythm. By allowing each spike to decay over its duration, each note encoded by an instrument signal 410 acts as a sort of temporal coordinate frame. That is, CPPN 100″ in effect knows at any time “where” it is within the duration of a note, by observing the stage of the note's decay. That information allows CPPN 100″ to create rhythm patterns that vary over the course of each note.

The level of each rhythm output 440A-C indicates the volume, strength, or amplitude of each drum strike. This allows CPPN 100″ to produce highly nuanced effects by varying volume. Two consecutive drum strikes within a rhythm output 440A-C—one tick after another—indicate two separate drum strikes rather than one continuous strike. CPPN 100″ generates a pause between strikes by outputting an inaudible value for some number of intervening ticks.

Though described above in the context of generating rhythm tracks from instrumental tracks, the scaffolding concept described herein can be used to transform any one type of musical input to another type of musical output. Music tracks include at least three types: harmony; melody; and rhythm. The scaffolding concept described herein can be used to transform any one of these types to any one of the other types. This scaffolding concept can generate (as a non-exhaustive list) harmony from melody, melody from harmony, or even melody from rhythm.

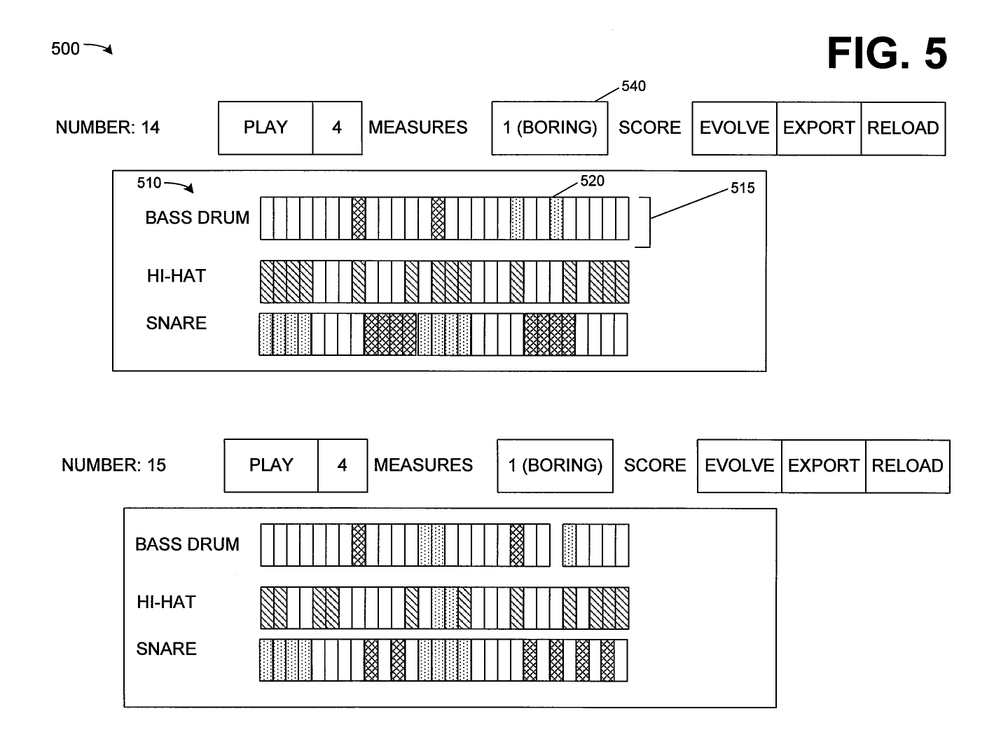

FIG. 5 illustrates a graphical user interface (GUI) 500 which allows a user to view a graphical representation or listen to the rhythm of each CPPN 100″ that is generated by logic 53. GUI 500 is similar to GUI 100 (from FIG. 3).

GUI 500 displays a single grid representation 510 which graphically depicts a particular rhythm generated by a CPPN 100″. Each grid 510 comprises a plurality of rows 515, each row corresponding to a specific percussion instrument. Examples include, but are not limited to, a “Bass Drum,” a “Snare Drum,” a “High Hat,” an “Open Cymbal,” and one or more Congo drums. Each row comprises a plurality of boxes 520 that are arranged sequentially to correspond temporally to the beat in the rhythm; if the box 520 exhibits no color or shading, no beat for the corresponding instrument is played. The strength at which the instrument beat is played is represented by the color of the box 520 (e.g., the darker the box 520, the stronger the instrument beat is played, and thus sounds). Rows 515 represent a discrete number of music measures.

GUI 500 allows a user to evaluate the acceptability of a generated composite rhythm signal 440, both aurally and visually. When the “Play” button is selected, the CPPN activation logic 54 plays the rhythm that is displayed graphically by the grid 510. And by examining the row 115 for an instrument, one can evaluate, based upon the visualization of the row 115, whether the rhythm for the instrument may or may not be an acceptable one. For example, a user can visually identify rhythms in which the bass is struck over and over again without pause. GUI 500 also allows a user to listen to the composite rhythm signal 440 in isolation, or along with instrumental signals 410 (which served as the scaffolding for the generated rhythm).

Once the user evaluates the rhythm by visually evaluating the grid 510 or listening to the rhythm, the user can rate the composite rhythm signal 440 by choosing a selection from a rating control 540 (e.g., poor/fair/excellent; numeric rating 1-5). Other embodiments may support ratings via descriptive words. After evaluating each composite rhythm signal 440, the user may then select the “Save Population” button to save the currently displayed rhythm. Notably, unlike the results of many evolutionary experiments, initial patterns generated by generation logic 53 are expected to have a sound that is already generally appropriate, because these patterns are functions of other parts of the song. This initial high quality underscores the contribution of the scaffolding to the structure of the generated rhythm.

Once one or more rhythms have been evaluated, the user may then activate the “Evolve” button to evolve new rhythms from specific evaluated rhythms. In some embodiments, the user selects one particular evaluated rhythm to evolve from (i.e. a “winner”). In other embodiments, the user sets a threshold rating, and all rhythms with a rating above this threshold are selected for evolution. In still other embodiments, the user selects a set of rhythms which are used in the evolution. The evolving logic 54 then evolves the selected CPPNs 100″ that correspond to the selected rhythms (as described above in connection with FIGS. 1 and 2). In this regard, the evolving logic 54 may perform speciation, mutate, and/or mate one or more CPPNs 100-110 and generate a new generation of rhythms generated by the generated CPPNs 200-210. In some embodiments, maximum magnitude of weight change is 0.1 and the probability of mutating an individual connection is 90%.

Because the NEAT algorithm includes complexification, the composite rhythm signals can become increasingly more elaborate as evolution progresses. The user can continue to generate new generations until satisfied.

FIG. 6 depicts an another example CPPN 100′″ indicative of the CPPNs 100-110 or CPPNs 200-210. CPPN 100′″ is similar to CPPNs 100″. However, CPPN 100′″ also includes an additional input: a temporal pattern 650, which is not part of the same song from which instrumental inputs 610 are taken. In this disclosure, this temporal pattern is called a “conductor”, as a analogy with the silent patterns expressed by a conductor's hands to an orchestra. CPPN 100′″ uses this additional input to provide additional structure to the composite rhythm output 640, by situating the notes of the individual rhythm outputs 640A-C within coordinate frames that describe how the user wants to vary at a meta-level. Temporal patterns 650 offer the user a subtle yet powerful mechanism to influence the overall structure of rhythm output 640, without the need for a note-by-note specification.

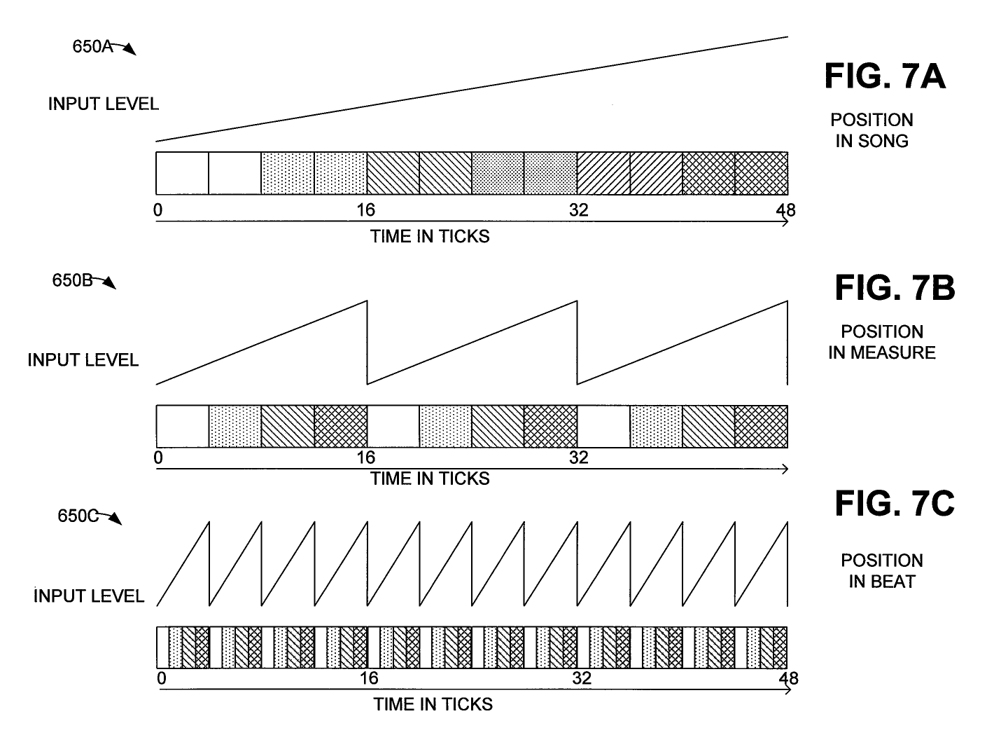

Examples of temporal pattern signals 650 are shown in FIGS. 7A-C. Each one of these temporal pattern signal corresponds to one of the timing inputs discussed in connection with FIG. 2: time, measure, and beat. FIG. 7A illustrates a linear function that indicates the current position in the song (“time-in-song1’), suggesting a smooth transition across the entire song. A time-in-song pattern 650A allows CPPN 100′″ to determine at every tick “where” it is within the song, which allows CPPN 100′″ to create patterns within the song as a whole and “understand” the overall structure of the song. A time-in-song pattern 650A produces a composite rhythm output 640 which is a function of the instrumental inputs 610 of the song, and of the time in the song. FIG. 78 illustrates a linear function that indicates the position within the current measure. A time-in-measure pattern 650B allows CPPN 100′″ to determine at every tick “where” it is within the current measure, which allows CPPN 100′″ to create patterns within measures and “understand” the measure structure of the song. A time-in-measure pattern 650B produces a composite rhythm output 640 which is a function of the instrumental inputs 610 of the song, and the time in the measure. FIG. 7C illustrates a linear function that indicates the position within the current beat. A time-in-beat pattern 650C produces a composite rhythm output 640 which is a function of the instrumental inputs 610 of the song, and the time in the beat. A time-in-measure pattern 650C allows CPPN 100′″ to determine at every tick “where” it is within the current beat, which allows CPPN 100′″ to create patterns within measures and “understand” the beat structure of the song.

Returning to FIG. 6, CPPN 100′″ is capable of producing multiple rhythm signals 640A-C, each of which can be associated (e.g., via a user interface) with a particular instrument that plays the signal (e.g., bass drum, hi-hat, snare drum, etc.) The inputs 610 to CPPN 100′″ are instrumental parts from a song, selected by a user, and temporal pattern (conductor) inputs. Although the instrument signals 610 do not directly represent timing signals, CPPN 100′″ derives timing signals from the instrument signals 610. CPPN generation logic 53 inputs the selected instrument signals 610 into each CPPN 100′″ over the course of the song in sequential order, and records the consequent rhythm outputs 440A-C, each of which represents a rhythm instrument being struck. Specifically, from time t=0 to time t=l (where l is the length of the song), CPPN generation logic 53 receives the song channel input signals 610 and samples the rhythm outputs 640A-C at discrete subintervals (ticks) up to l.

CPPN 100′″ derives timing information from instrument signals and the conductors 610 as follows. CPPN 100′″ represents individual notes within each instrument signal 610 as spikes that begin high and decrease or decay linearly. The period of decay is equivalent to the duration of the note. The set of input signals 610 is divided into N ticks per beat. At each tick, the entire vector of note spike values at that discrete moment in time is provided as input to the CPPN 100′″. In this manner, CPPN 100′″ derives timing information from the instrument signals 610, while ignoring pitch, which is unnecessary to appreciate rhythm. By allowing each spike to decay over its duration, each note encoded by an instrument signal 610 acts as a sort of temporal coordinate frame. That is, CPPN 100′″ in effects knows at any time “where” it is within the duration of a note, by observing the stage of the note's decay. That information allows CPPN 100″ to create rhythm patterns that vary over the course of each note.

The level of each rhythm output 640A-C indicates the volume, strength, or amplitude of each drum strike. This allows CPPN 100′″ to produce highly nuanced effects by varying volume. Two consecutive drum strikes within a rhythm output 640A-C—one tick after another—indicate two separate drum strikes rather than one continuous strike. CPPN 100″ generates a pause between strikes by outputting an inaudible value for some number of intervening ticks.

The regular temporal patterns described above are regular, in that a beat pattern for a 4-beat measure can be described as “short, short, short, short”. The patterns are regular because each note is the same duration. Some embodiments of CPPN 100′ and CPPN 100′″ also support arbitrary or artificial temporal patterns. One example of an arbitrary temporal pattern is: long, long, short, short (repeating every measure). When this pattern is used as input, CPPN 100′″ uses “long, long, short, short” as a temporal motif. When this temporal motif is combined with an instrumental input signal, the rhythm output 640 produced by a particular CPPN 100′″ combines, or interweaves, this temporal motif with the instrumental signal. The result is a rhythm which is perceived by a user to have a “long-long-short-short-ness”:

Another example of an arbitrary temporal pattern, defined in relation to the entire song rather than a measure, is a spike that covers the first two-thirds of the song, and another spike that covers the remaining third. The result is a song with a crescendo, getting more dramatic, quickly, at the end.

Such arbitrary temporal patterns may or not be pleasing to the ear. But a CPPN that produces rhythms which incorporates such patterns is nonetheless useful because a user is involved in grading and selecting pleasing rhythms, and it is these approved rhythms which are used to evolve the next generation. Thus, a generated “long, long, short, short” rhythm which does not sound good when played along with a particular song would presumably not be selected by the user for evolution into the next generation.

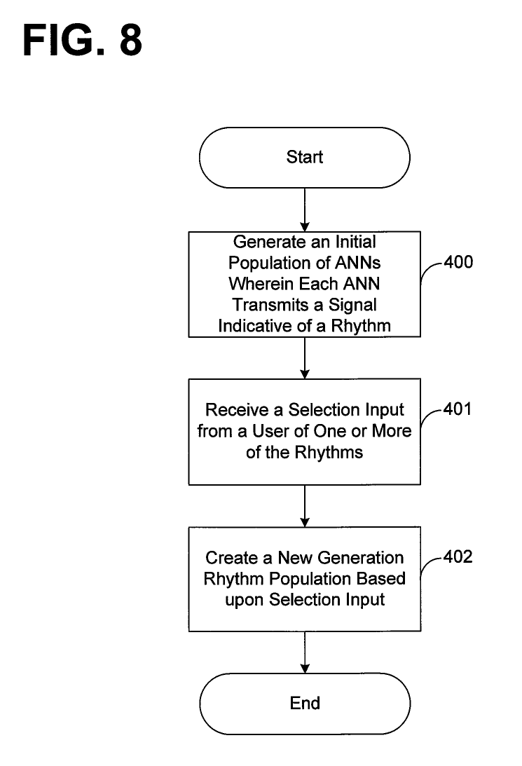

FIG. 8 shows a flowchart implemented by an example system 10 for evolving rhythmic patterns. As indicated in step 100″, the system 10 generates an initial population of CPPNs wherein each CPPN transmits a signal indicative of a rhythm. In this regard, the CPPNs generated can have a plurality of inputs such as inputs 11-13 (FIG. Z), and the rhythms generated by the CPPNs are based upon those inputs.

Once the CPPNs are generated, the user may evaluate the rhythms visually and audibly as described herein e.g., GUIs 300, 500). The system 10 then receives a selection input form a user of one or more of the rhythms, as indicated in step 801. As described with reference to the GUIs in FIGS. 3 and 5, the user may rate each rhythm for example, on a scale from excellent to poor.

The system 10 creates a new generation of CPPNs based upon the selection input. In this regard, the system 10 generates CPPNs 200-210 through speciation, mutation, and/or mating based upon those rhythms that the user selected and their corresponding CPPNs. The process of selection and reproduction then repeats until the user is satisfied. Various programs comprising logic have been described above. Those programs can be stored on any computer-readable medium for use by or in connection with any computer-related system or method. In the context of this document, a computer readable medium is an electronic, magnetic, optical, or other physical device or means (e.g., memory) that can contain or store computer instructions for use by or in connection with a computer-related system or method.

What is claimed is:

1. A method, implemented in a computer, for generating a rhythm track for a song, comprising the steps of:
receiving a scaffolding input from a song into an artificial neural network (ANN); and
producing a rhythm output from the ANN, based upon the scaffolding input.

2. The method of claim 1, wherein the scaffolding input is an instrumental part from the song.

3. The method of claim 1, wherein the scaffolding input is an instrumental track from the song, including a vocal track but excluding a rhythm track.

4. The method of claim 1, further comprising:
receiving, from a user, a selection corresponding to the scaffolding input.

5. The method of claim 1, further comprising:
deriving timing information from the scaffolding input; and
producing the rhythm output from the ANN, based upon the derived timing information.

6. The method of claim 1, wherein the producing comprises:
producing an initial population of rhythm outputs from the ANN, based upon the scaffolding input; and
evolving a next generation population of rhythm outputs from the ANN, based upon a user selection from the initial population and upon the initial population,
wherein the rhythm output produced from the ANN is one of the next generation population.

7. A method, implemented in a computer, for generating one type of music track from another type of music track, comprising the steps of:
receiving a music track input having a first type into an artificial neural network (ANN); and
producing a music track output having a second type from the ANN, based upon the music track input having the first type.

8. The method of claim 7, wherein the first type is rhythm and the second type is melody.

9. The method of claim 7, wherein the first type is melody and the second type is harmony.

10. The method of claim 7, wherein the first type is melody and the second type is rhythm.

11. The method of claim 7, further comprising:
receiving, from a user, a selection corresponding to the scaffolding input.

12. The method of claim 7, further comprising:
deriving timing information from the scaffolding input; and
producing the rhythm output from the ANN, based upon the derived timing information.

13. The method of claim 7, wherein the producing comprises:
producing an initial population of rhythm outputs from the ANN, based upon the scaffolding input; and
evolving a next generation population of rhythm outputs from the ANN, based upon a user selection from the initial population and upon the initial population,
wherein the rhythm output produced from the ANN is one of the next generation population.

14. A method, implemented in a computer, for generating a rhythm track for a song, comprising the steps of:
receiving a scaffolding input from a song into an artificial neural network (ANN);
receiving a conductor input into the ANN; and
producing a rhythm output from the ANN, based upon the scaffolding input and the conductor input.

15. The method of claim 14, wherein the conductor input comprises user-defined timing information.

16. The method of claim 14, wherein the conductor input is indicative of a number of measures of a song.

17. The method of claim 14, wherein the conductor input is indicative of a beat of a song.

18. The method of claim 14, wherein the conductor input is indicative of a time of a song.

19. The method of claim 14, wherein the scaffolding input is an instrumental part from the song.

20. The method of claim 14, wherein the scaffolding input is an instrumental track from the song, including a vocal track but excluding a rhythm track.
